(19) United States
(12) Patent Application Publication
(10) Pub. No.: US 2023/0191839 A1
(43) Pub. Date: Jun. 22, 2023

(54) PNEUMATIC TIRE

(71) Applicant: The Goodyear Tire & Rubber Company, Akron, OH (US)

(72) Inventors: Jonathan Michael DiMonte, Stow, OH (US); Brent Reynir Koch, Cleveland, OH (US); Mark Allen Grund, Tallmadge, OH (US); Edward Earl Simmons, Union City, TN (US)

(21) Appl. No.: 18/049,337

(22) Filed: Oct. 25, 2022

Related U.S. Application Data
(60) Provisional application No. 63/265,622, filed on Dec. 17, 2021.

(51) Int. Cl. B60C 9/02; B29D 30/30

(52) U.S. Cl. CPC B60C 9/0207; B29D 30/30; B60C 2009/0475

(57) ABSTRACT

A pneumatic tire is disclosed and comprises a tread, a belt package located radially beneath the tread, a pair of bead cores, a pair of sidewalls, with each sidewall extending between the tread and each bead core, a carcass comprising a first carcass ply extending under the tread and being anchored to each bead core, wherein the first carcass ply has a reinforced stiffener applied thereto, wherein the carcass further comprising a second carcass ply, wherein the second carcass ply extends under the tread and is anchored to each bead core.

### FIELD OF THE INVENTION

This invention relates to a pneumatic tire, and more particularly, to a pneumatic tire having improved puncture resistance and durability.

### BACKGROUND OF THE INVENTION

Many types of vehicles are driven off road or in rugged road conditions, from the off the road enthusiast in a light truck or all terrain vehicle, to massive earth mover vehicles. The commonality often experienced by these vehicle tires are tire cuts and rock penetration, particularly in the sidewall area. It is thus desired to have an improved tire with a sidewall that increases cut resistance and improves the strength of the sidewall.

### Definitions

“Apex” means a non-reinforced elastomer positioned radially above a bead core.

“Aspect ratio” of the tire means the ratio of its section height (SH) to its section width (SW) multiplied by 100 percent for expression as a percentage.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Bias ply tire” means a tire having a carcass with reinforcing cords in the carcass ply extending diagonally across the tire from bead core to bead core at about a 25-50 degree angle with respect to the equatorial plane of the tire. Cords run at opposite angles in alternate layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Extensible” means a cable having a relative elongation at break of greater than 0.2 percent at 10 percent of the breaking load, when measured from a cord extracted from a cured tire.

“Equatorial plane (EP)” means the plane perpendicular to the tire's axis of rotation and passing through the center of its tread.

“Flipper” means a reinforced fabric wrapped about the bead core and apex.

“Footprint” means the contact patch or area of contact of the tire tread with a flat surface at zero speed and under normal load and pressure

“Innerliner” means the layer or layers of elastomer or other material that form the inside surface of a tubeless tire and that contain the inflating fluid within the tire.

“Net-to-gross ratio” means the ratio of the tire tread rubber that makes contact with the road surface while in the footprint, divided by the area of the tread in the footprint, including non-contacting portions such as grooves.

“Radial-ply tire” means a belted or circumferentially-restricted pneumatic tire in which the ply cords which extend from bead to bead are laid at cord angles between 65-90 degrees with respect to the equatorial plane of the tire.

“Section height” (SH) means the radial distance from the nominal rim diameter to the outer diameter of the tire at its equatorial plane.

### BRIEF DESCRIPTION OF THE DRAWINGS

The invention will be described by way of example and with reference to the accompanying drawings in which:

FIG. 1 illustrates a partial cross-section through a tire midplane of a first embodiment of a radial tire 100 of the present invention;

FIG. 2 illustrates a front view of a tire ply and a pair of reinforced stiffeners; and

FIG. 3 illustrates an illustration of a first embodiment of a tire building process and order in which the tire components are assembled useful for forming the tire of FIG. 1.

### DETAILED DESCRIPTION OF AN EXAMPLE EMBODIMENT THE INVENTION

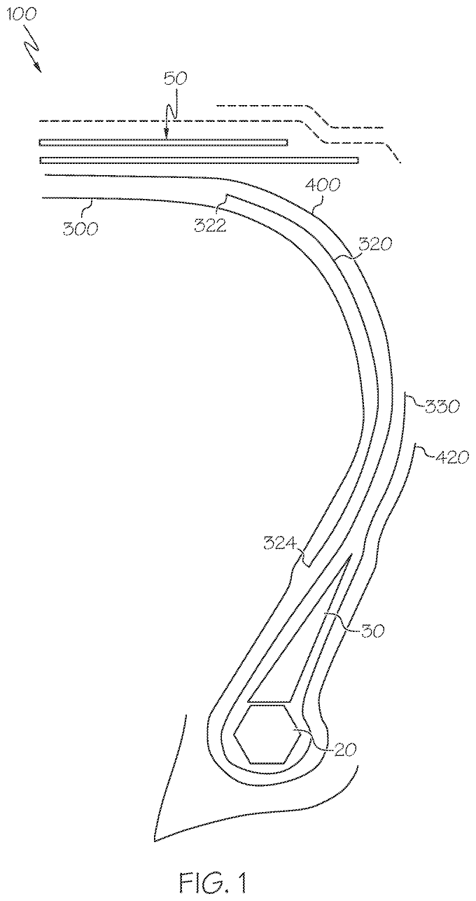

FIG. 1 illustrates a partial cross-section of an exemplary radial tire 100 of the present invention. The non-illustrated half of the tire is symmetrical to that illustrated, unless specifically identified otherwise. While one type of tire cross-sectional profile and basic internal construction is illustrated, the disclosed invention may be applicable for a light truck tires, radial medium tires, heavy load tire, industrial tires, off-the-road tires, mining tires, agricultural tires, all-terrain tires, aircraft tires or other types of tires. One skilled in the art will appreciate that for each type of tire, the tire cross-sectional profile, the tread configuration, and materials of construction will be selected for the desired performance of the tire and may not be identical to what is illustrated.

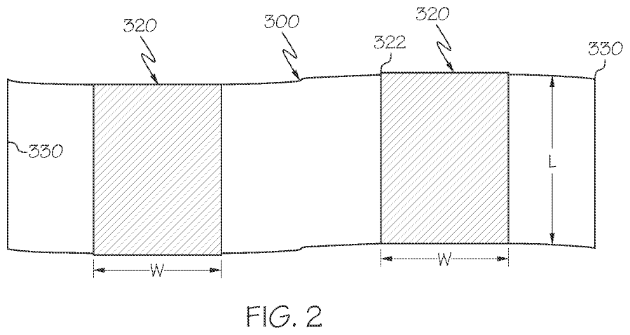

The tire 100 of the present invention has a pair of axially spaced bead portions with an annular bead core 20 provided therein. The tire 100 further includes an optional apex 30 which extends radially outward of the bead core 20, and is preferably triangular in cross-sectional shape. The tire 100 further includes a first carcass reinforcing ply 300 extending radially inward of the crown portion of the tire and extending from one bead core to the other bead core 20. The first reinforcing ply 300 is wound around each bead core and apex, forming turnup end portions 330, which terminate radially outward of each bead core. The first reinforcing ply 300 further includes a reinforced stiffener 320 for positioning in each sidewall of the tire for enhanced durability and stiffness. The reinforced stiffener 320 may be a single sheet or divided into two spaced apart discrete reinforced stiffeners. The reinforced stiffeners 320 are preassembled to the first carcass reinforcing ply 300 as shown in FIG. 2.

The pneumatic tire of the present invention further includes a second carcass reinforcing ply 400, which extends radially inward from the crown portion of the tire, and wraps around the bead and apex forming a turn up portion 420. The second carcass reinforcing ply 400 is located radially outward of the first carcass reinforcing ply 300.

The reinforced stiffener 320 has a first end 322 that is positioned between the first and second reinforcing ply 300,400 and a lateral end 52 of a belt package 50. The reinforced stiffener 320 has a second end 324 that is positioned between the down portions of the first and second reinforcing plies 300,400. The second end is preferably located radially inward of the apex. The second end is also preferably radially inward of turnup 320 and turnup 420.

The reinforced stiffener 320 may be formed of reinforced tire ply and may have parallel reinforcement cords that are oriented in any desired direction such as being inclined at an angle of 0 to 90 relative to the circumferential direction of the tire. The reinforced stiffener 320 may be formed of reinforced tire ply having reinforcement cords of 1000/2, 2000/2 or 1500/2. The orientation/angle of the reinforcement cords of the stiffener are preferably in the range of 70 to 100 degrees relative to the tire circumferential direction. The reinforced stiffener may also be formed of a fabric with reinforcement cords extending in two directions perpendicular to each other. The reinforcement cords may comprise aramid, polyester, nylon, PET, PEN, or blends or hybrids thereof.

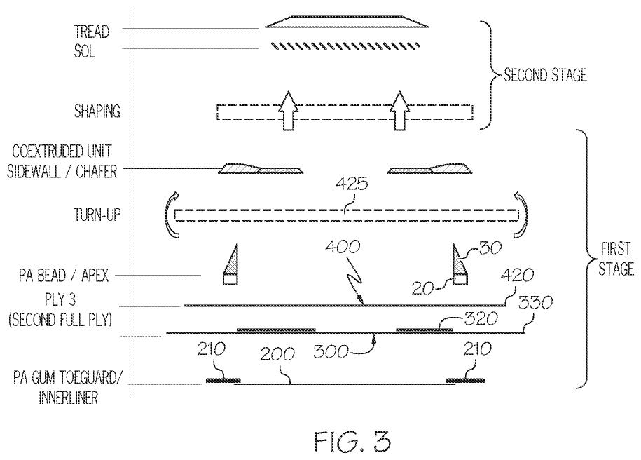

The method of manufacturing the present invention of the tire of FIG. 1 is described as follows. As shown in FIG. 3, an inner liner 200 with preassembled toe guards 210 are applied to a conventional tire building drum 420. Next, the first carcass reinforcing ply 500 is applied to the tire building drum 425. The first carcass reinforcing ply 300 preferably includes split reinforced stiffeners 320 which are preassembled to the first carcass reinforcing ply 300 prior to application to the tire building drum. Next, the carcass subassembly 300 of the first carcass reinforcing ply 300 and stiffeners 320 is applied to the tire building drum. After the bead and apex subassembly is applied to the tire building drum, the outer lateral ends of the first and second carcass plies are turned up about the bead and apex. The first stage tire building process is then complete. The first stage tire building carcass is then shaped into a toroid, and the tread, belt package and sidewalls are applied. Alternatively, the sidewalls and chafer are preassembled and applied to the first stage tire building carcass.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a tread, a belt package located radially beneath the tread, a pair of bead cores, a pair of sidewalls, with each sidewall extending between the tread and each bead core, a carcass comprising a first carcass ply extending under the tread and being anchored to each bead core, wherein the first carcass ply has a reinforced stiffener applied thereto, wherein the carcass further comprising a second carcass ply, wherein the second carcass ply extends under the tread and is anchored to each bead core.

2. The pneumatic tire of claim 1 wherein the reinforced stiffener is positioned in the sidewall of the tire between the first and second carcass ply.

3. The pneumatic tire of claim 1 wherein the reinforced stiffener has a first end which is secured between a lateral outer end of the belt package and between the first and second carcass plies.

4. The pneumatic tire of claim 1 wherein each bead core has a radially outer apex, and the reinforced stiffener has a second end which is located radially inward of the radially outer apex.

5. The pneumatic tire of claim 1 wherein the tire has a shoulder area extending between the tread and each sidewall, and wherein the reinforced stiffener is positioned in each shoulder area.

6. The pneumatic tire of claim 5 wherein the shoulder area has a first and second layer of reinforcement ply and the reinforced stiffener positioned therein.

7. The pneumatic tire of claim 1 wherein the reinforced stiffener is divided into two separate strips, with one strip being positioned in each sidewall.

8. The pneumatic tire of claim 1 wherein the reinforced stiffener is formed of tire ply having parallel reinforcement cords.

9. The pneumatic tire of claim 8 wherein the reinforcement cords of the reinforced stiffener are angled in the range of 50 to 115 degrees with respect to the tire circumferential direction.

10. The pneumatic tire of claim 1 wherein the reinforcement cords of the reinforced stiffener are formed of polyester, nylon, aramid, PET, PEN and blends thereof.

11. A method of building a tire on a tire building drum, the method comprising the steps of:
applying an innerliner to the tire building drum,
applying a first layer of ply over the inner liner, wherein the first layer of ply has a reinforced stiffener secured thereto,
applying a second layer of ply, setting a first and second bead core over each end of the first and second layer of ply and then turning up each lateral end of the first and second layer of ply forming a respective turned up end, wherein the reinforced stiffener is positioned in the tire sidewall area of the finished tire.

12. The method of claim 11 wherein the reinforced stiffener is positioned between the first and the second carcass ply.

13. The method of claim 11 wherein the reinforced stiffener is positioned in each sidewall, extending from the belt package to an apex of each bead core.

14. The method of claim 11 wherein each bead core has a radially outer apex, and the reinforced stiffener has a second end which is located radially inward of the radially outer apex.

15. The method of claim 11 wherein the tire has a shoulder area extending between the tread and each sidewall, and wherein the reinforced stiffener is positioned in each shoulder area.

16. The method of claim 11 wherein the shoulder area has a first and second layer of reinforcement ply and the reinforced stiffener positioned therein.

17. The method of claim 11 wherein the reinforced stiffener is divided into two separate strips, with one strip being positioned in each sidewall.

18. The method of claim 11 wherein the reinforced stiffener is formed of tire ply having parallel reinforcement cords.

19. A pneumatic tire comprising a tread, a belt package located radially beneath the tread, a pair of bead cores, a pair of sidewalls, with each sidewall extending between the tread and each bead core, a carcass comprising a first carcass ply extending under the tread and being anchored to each bead core, wherein the carcass further comprising a second carcass ply, wherein the second carcass ply extends under the tread and is anchored to each bead core, and wherein a reinforced stiffener is positioned in the sidewall of the tire.

20. The tire of claim 19 wherein the reinforced stiffener is positioned between the first carcass ply and the second carcass ply.
